(19) United States
(12) Patent Application Publication
(10) Pub. No.: US 2011/0029350 A1
(43) Pub. Date: Feb. 3, 2011

(54) METHOD AND SYSTEM FOR CALENDARING EVENTS

(76) Inventors: Edith Ronen, Ramat-Hasharon (IL); Benny Keinan, Rehovot (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/511,200

(22) Filed: Jul. 29, 2009

(51) Int. Cl. G06Q 10/00; G06T 11/20

(52) U.S. Cl. 705/9; 345/440

(57) ABSTRACT

A method of calendaring events including determining aggregated information of a plurality of events over a time period and correlative with individual event information stored in a calendar. The method may also include generating a calendar view of the calendar comprising the aggregated information. Further, the method may include determining statistical information of the plurality of events correlative to the individual event information comprising a parameter associated with individual events in the plurality of events, and generating a statistical view of the calendar comprising the statistical information.

### BACKGROUND

Scheduled or planned events are often managed via a calendar or calendar view. There are several existing calendaring solutions available, such as Microsoft Outlook, Google Calendar, and the like, that provide for display of scheduled events. The events may be human events or events with automated systems, and may be associated with a vast range of activities. Such activities may include typical daily personal or business tasks, project management implementation, construction activities, service plans, and so on.

### BRIEF DESCRIPTION OF THE DRAWINGS

Certain exemplary embodiments are described in the following detailed description and in reference to the drawings, in which:

FIG. 1 is a diagrammatical representation of a user view having a calendar in accordance with an exemplary embodiment of the present invention;

FIG. 2 is a method of determining and displaying the user views of a calendar and associated information in accordance with an exemplary embodiment of a the present invention;

FIG. 3 is a diagrammatical representation of computer network system in accordance with an exemplary embodiment of the present invention; and

FIG. 4 is a diagrammatical representation of memory coupled with a processor, the memory having computer-executable code stored thereon for execution of a calendar of planned events in accordance with an exemplary embodiment of the present invention.

### DETAILED DESCRIPTION OF SPECIFIC EMBODIMENTS

In managing scheduled events in a calendar view, especially with a high volume of events, there may be a problem of displaying all events on a calendar view and also with identifying relevant or important events. Existing calendaring solutions available, such as Microsoft Outlook, Google Calendar, and the like, provide for display of scheduled events. However, to display a high volume of events, these approaches may overlay the events on top of each other, place the events side-by-side while reducing the text size, and the like. Unfortunately, these conventional approaches may require the user to search for meaningful patterns that are not readily visible. Consequently, the user may miss important events, spend excessive time in reviewing the events, and so on. Further, the conventional approaches may only provide for display of a limited number of events, an arbitrariness of displayed events, and a general inability to analyze the data associated with the planned events.

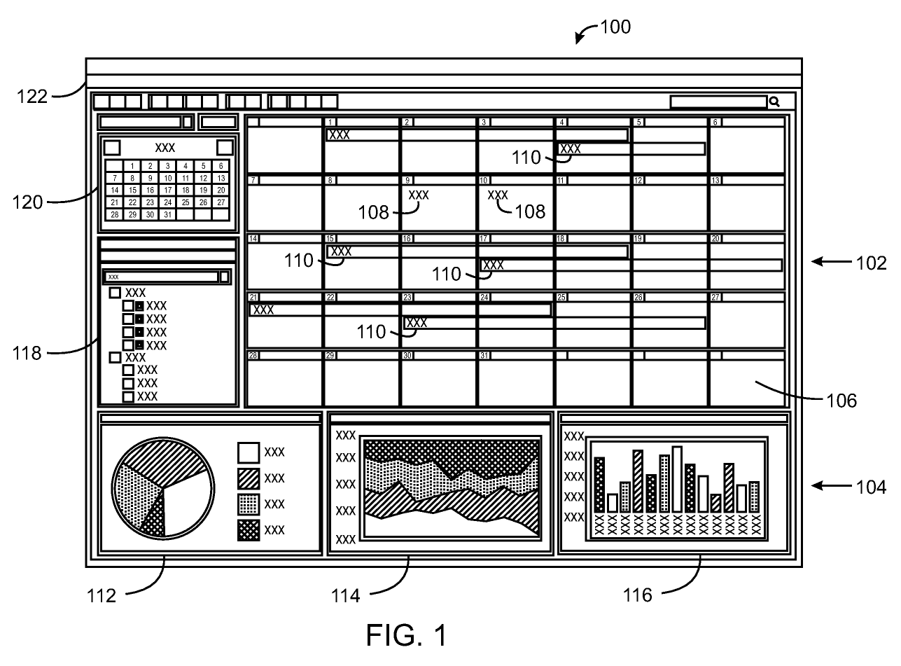

In contrast, exemplary embodiments of the present invention provide for a calendar view that displays aggregated data of multiple events on a given day or time period and a graphical or statistical view that provides statistical analysis data. The calendar view may display a fixed time frame and support standard calendaring navigation abilities, as discussed further with respect to FIG. 1. Each cell in the view may represent a single day or other time segment and, again, may included aggregated numeric or textual information for the specific day, such as the total number of scheduled events. In exemplary embodiments of the present invention, coherent management of a high volume of planned events is facilitated by not necessarily displaying single events on the initial overall calendar. Further, in exemplary embodiments, filtering abilities may be available to filter the relevant events based on event attributes such as risk, priority, status, and so forth. As for the statistical view, it may consist of a number of graphs or tables (i.e., tabulated data), each representing a different statistical analysis of the events relevant to the selected time frame. For example, graphs may include a pie chart representing the events breakdown by risk, a plot representing the events distribution over time, and so on.

In exemplary embodiments of the present invention, the user can interact with both views in order to filter out and drill down to the relevant events. Further, both views may generally stay synchronized. Moreover, both views may be portions displayed on a single overall view. In operation, the user may navigate through the calendar, which may result in an update of the statistical graphs or tables. In addition, the user may drill down through the statistical view, such as by clicking on portions of the graphs or tables, which may result in an update of the aggregated information shown on the calendar view. In one example, the user may click on the high risk portion of a pie chart (if a pie chart is employed) in order to filter only high risk events or changes, which, again update the aggregated data on the calendar view.

FIG. 1 is an event calendar 100 which stores and presents scheduled events and associated information. The event calendar 100 may be particularly beneficial in presenting and managing a high volume of planned events (for example, greater than 100 events in a single day or week). In exemplary embodiments of the present invention, the events may be a high volume of planned changes in a project or ongoing maintenance program, such as in a computer network system or datacenter. Such exemplary embodiments may be beneficial, for example, in managing a high volume of change records.

The calendar 100 has a calendar portion 102 and a graphical or statistical portion 104. The calendar portion 102 may be presented in a multi-year view, annual view, monthly view (as shown), weekly view, daily view, hourly view, and so forth. The cells 106 of the calendar portion 102 may be in days (as shown) or other time duration, depending on the desired frequency and overall view, for example. The calendar potion 102 may provide aggregated information or data 108 for a given day 106 or for other time segment. The aggregated data 108 may be according to user selection, such as with the user selection of a desired parameter (for example, risk, priority, status, etc.), a particular group of events, a certain time frame, and the like. Examples of the aggregated data 108 displayed on a given day 106 may be one or more numerical values or text. In exemplary embodiments of the present invention, the aggregated data 108 is a numerical value to indicate the number of events, the overall risk or priority of events, average or median risk or priority of events, the number of high risk or high priority events, status of events, etc. Also, metadata 110 or other information on the events may be provided across the time frame the user views. For example, the metadata could indicate what type of event is displayed. An event could mark a time frame that allows or disallows taking specific actions. The meta data for this event may also indicate the length of the time frame. For example, specific actions (such as maintenance operations) could be performed on weekends, but may be prohibited from being performed on weekdays. In these cases, the events meta data could indicate whether maintenance activities are allowed or disallowed at the time of the event.

The statistical portion 104 displays statistical analysis data for the selected time frame of the calendar 100. A user may control the displayed data by navigating through the calendar portion 102, or by drilling down through the statistical view 104, and the like. The statistical portion 104 may be displayed with the calendar portion 102, as depicted. On the other hand, the statistical portion 104 may be displayed separately. In either case, in all, the statistical data on the events the user is interested in may be displayed. In the illustrated exemplary embodiment, depicted in the statistical portion 102 section are a pie chart 112, plot 114, and bar chart 116.

It should be emphasized, however, that these graphical representations in the illustrated exemplary embodiment are only examples and not meant to limit the present invention. In the illustrated example, the pie chart 112 breaks down the number of events or changes by risk (for example, each event may have been previously assigned a risk numerical value such as in the range of 0 to 100). The parameter may also be a numerical value indicative of priority, status, and so on. The parameter depicted in the pie chart 112 may be user selectable. The plot 114 is a breakdown of the events or changes over time. The breakdown may be based on the desired parameter that may be selected by the user. The bar chart 11 6, similar to the pie chart, is a break-down of the planned events based on the desired parameter which may be user selectable. In sum, in exemplary embodiments of the present invention, the user may select the type of graphical or tabular representation and also select the type of metrics the user would like to see. Moreover, as indicated, these statistical views may provide the user further filtering and drill down capabilities on the events that interest the user.

In the illustrated exemplary embodiment of FIG. 1, the calendar 100 includes a quick filtering control portion 118. The filtering control portion 118 may facilitate the user to select only the events which interest the user. Beneficially, the resulting statistical data in the statistical portion 104, or the aggregated data 108 in the calendar potion 102, and so on, may be based only on the selected events. In this exemplary embodiment of the present invention, the calendar 100 also includes a calendar control portion 120 which may facilitate user-navigation (for example, time-based) of the calendar 100 and calendar portion 102. Lastly, the calendar 100 may be presented in a browser or other format and include various task bars 122 for user functions and data entry.

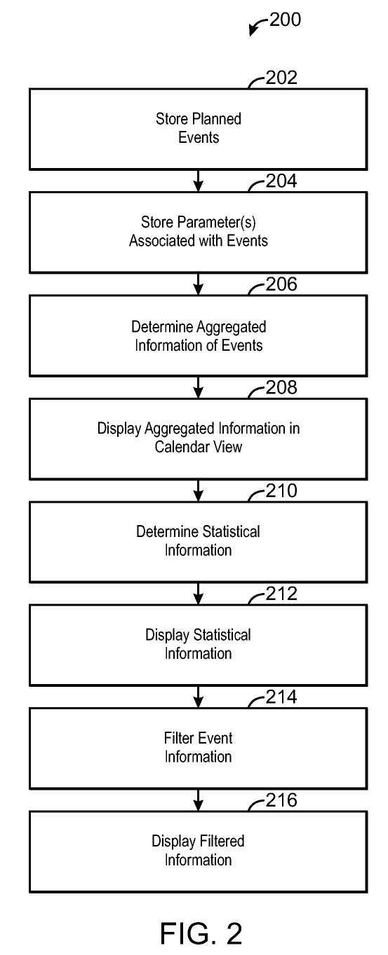

FIG. 2 is a method 200 of managing planned events via a calendar, such as the calendar 100 of FIG. 1. The method 200 may beneficial for managing and evaluating a high volume of scheduled events. Initially, planned events may be stored (block 202), for example, entered by a user via the calendar 100 into a memory device. Further, parameters, such as risk, priority, status, etc., associated with the events may also be entered and stored (block 204). As discussed, from the entries of events and associated parameters, aggregated data or information that summarizes multiple invents may be computed and displayed (blocks 206 and 208). Again, the aggregated data may include aggregated numeric information for specific days, for example, such as the total number of scheduled events. Moreover, the aggregated data may be changed via manipulation of the calendar by the user, for example, based on the desired metric or time frame, and the like. In addition, statistical information relating to the stored planned events may be computed and displayed in graphical form, tabular form, etc. (blocks 210 and 212). The statistical information computed and displayed may be based on a particular time frame, desired parameters or metrics, and the like, and may be user selectable and manipulated. Lastly, the method 200 may provide for filtering (block 214) of the event information and resulting display (block 216) of the filtered results. As indicated, such filtering may change the aggregated data and/or statistical formats and data presented. Such filtering may be based on time frames, parameters, number of events, and so forth.

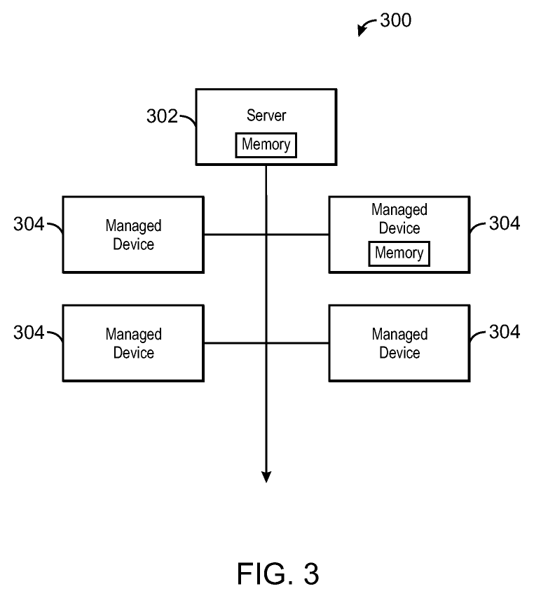

FIG. 3 is a computer network system 300 that may employ a calendar in accordance with an exemplary embodiment of the present invention. A server 302 or managed device 304 (for example, a computer, laptop, server, etc.) may store in memory all or components of a calendar system, such as the calendar 100 of FIG. 1. The managed devices 304 may be coupled by a network backbone. Data and information regarding the planned events and associated parameters may be stored in memory devices in the server 302 or in the managed devices 304 in the network system 300. The server 302 and managed devices 304 may provide a user interface (for example, display monitor, keyboard, mouse, etc.) to facilitate storing and using the calendar by an administrator or user, and to facilitate managing and evaluating the planned events in the calendar. The managed devices 304 may also include printers, scanners, and other peripherals. Moreover, as can be appreciated, the server 302 and managed devices 304 may provide the computational power, such as a processor, to facilitate the various functions of the calendar including data entry, calculations, statistical analysis, filtering, display, and so on. Lastly, it should be noted that the system 300 can be more complex than depicted, such as having sub branches with additional devices, connections to an external network such as the internet, and so on. Further, the system 300 could be, for example, a user or provider system, a datacenter, and so forth.

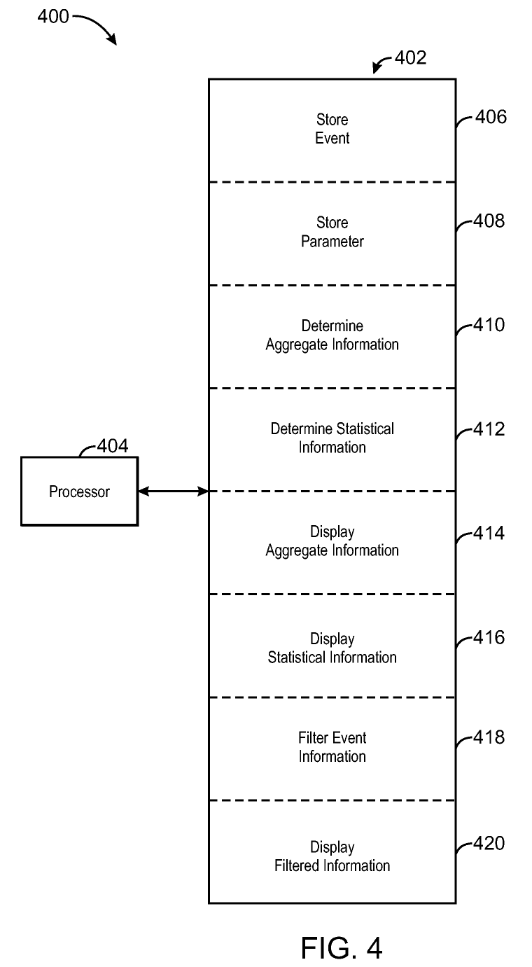

FIG. 4 is a system 400 having a memory device(s) 402 coupled with a processor 404. The memory device(s) 402 may have computer-executable code stored thereon for execution (for example, via the processor 404) of a calendar having planned events in accordance with an exemplary embodiment of the present invention. Software modules stored in the memory 402 may include code for exemplary embodiments of the present invention, such as a module 406 for storing planned events, a module 408 for storing associated parameters, a module 410 for determining or calculating aggregated information data of events, a module 412 for determining or computing statistical and graphical representations of the events (i.e., based on associated parameters and other user-selectable criteria), and a module 414 for displaying the statistical information. The software modules stored in the memory 402 may also include a module 418 for filtering event and statistical information, as discussed above, and a module 420 displaying the resulting filter information, such as in a calendar view or statistical view.

What is claimed is:

1. A method of calendaring events, comprising:
determining aggregated information of a plurality of events over a time period and correlative with individual event information stored in a calendar;
generating a calendar view of the calendar comprising the aggregated information;
determining statistical information of the plurality of events correlative to the individual event information comprising a parameter associated with individual events in the plurality of events; and
generating a statistical view of the calendar comprising the statistical information.

2. The method of claim 1, wherein the plurality of events comprises greater than 100 individual events.

3. The method of claim 1, wherein the aggregated information comprises a numerical value of an amount of the individual events in the plurality of events.

4. The method of claim 1, wherein the time period comprises a day.

5. The method of claim 1, wherein generating the calendar view comprises displaying the aggregated information in a cell of the calendar view.

6. The method of claim 1, wherein individual events of the plurality events are not presented in the calendar view.

7. The method of claim 1, wherein the parameter comprises risk, priority, or status, or any combination thereof.

8. The method of claim 1, wherein the parameter is user-selectable.

9. The method of claim 1, wherein determining statistical information comprising determining statistical information of a second plurality of events over a second time period, wherein the second plurality of events comprises individual events of the plurality of events.

10. The method of claim 9, wherein the time period comprises a day, and the second time period comprises more than a day.

11. The method of claim 1, comprising displaying metadata associated with the plurality of events.

12. The method of claim 1, wherein the statistical view comprises displaying a graph or a table, or a combination thereof.

13. The method of claim 1, comprising filtering individual event information of the plurality of events.

14. The method of claim 13, wherein filtering comprises filtering individual event information of the plurality of events based on the parameter.

15. The method of claim 13, comprising displaying results of the filtered event information in the statistical view.

16. The method of claim 13, comprising updating the aggregated information in response to filtering individual event information.

17. A computer system or network for calendaring events, comprising:
a processor; and
one or more memory devices coupled to the processor, the one or more memory devices comprising code stored therein to execute:
determining aggregated information of a plurality of events over a time period and correlative with individual event information stored in a calendar;
generating a calendar view of the calendar comprising the aggregated information;
determining statistical information of the plurality of events correlative to the individual event information comprising a parameter associated with individual events in the plurality of events; and
generating a statistical view of the calendar comprising the statistical information.

18. The computer system or network of claim 17, wherein the one or memory devices comprises code to execute filtering individual event information of the plurality of events based on the parameter.

19. A tangible, computer-readable medium, comprising code configured to:
determine aggregated information of a plurality of events over a time period and correlative with individual event information stored in a calendar;
generate a calendar view of the calendar comprising aggregated information;
determine statistical information of the plurality of events correlative to the individual event information comprising a parameter associated with individual events in the plurality of events; and
generate a statistical view of the calendar comprising the statistical information.

20. The computer system or network of claim 19, wherein the code is configure to filter individual event information of the plurality of events based on the parameter.
